(19) United States
(12) Patent Application Publication
(10) Pub. No.: US 2026/0116070 A1
(43) Pub. Date: Apr. 30, 2026

(54) METHOD OF MANUFACTURING LIQUID EJECTION HEAD, LIQUID EJECTION HEAD, AND LIQUID EJECTION APPARATUS

(71) Applicant: CANON KABUSHIKI KAISHA, Tokyo (JP)

(72) Inventor: MANABU OTSUKA, Kanagawa (JP)

(21) Appl. No.: 19/367,472

(22) Filed: Oct. 23, 2025

(30) Foreign Application Priority Data
Oct. 24, 2024 (JP) 2024-187559
Jul. 23, 2025 (JP) 2025-123336

(51) Int. Cl. B41J 2/14; B41J 2/16

(52) U.S. Cl. CPC B41J 2/14233; B41J 2/161; B41J 2/1623

(57) ABSTRACT

An object of the present disclosure is to prevent protrusion of an adhesive into openings provided in a substrate of a liquid ejection head. An embodiment of the present disclosure is a method of manufacturing a liquid ejection head in which a recess is formed to have such a width in an X direction and such a width in a Y direction as to satisfy P1≥P3≥P2, where P1 is a pressure generated on a liquid surface being an end surface of an adhesive after formation of a joint region but before curing that abuts a channel in the joint region in a case where the adhesive does not protrude from the joint region, P2 is a pressure generated on a liquid surface being an end surface of the adhesive that abuts the channel in a case where the adhesive protrudes from the joint region.

### BACKGROUND

### Field of the Technology

The present disclosure relates to a method of manufacturing a liquid ejection head, a liquid ejection head, and a liquid ejection apparatus.

### Description of the Related Art

In recent years, the manufacturing of functional devices such as micro-electromechanical systems (MEMS) including pressure sensors and acceleration sensors and microfluidic devices includes fabrication of devices with joined substrates obtained by joining substrates with an adhesive therebetween. One example of those is a liquid ejection head that ejects liquids. An example of the liquid ejection head is an inkjet print head.

Such an inkjet print head has energy generation elements that generates energy for ejecting inks. Also, on the front surface of its substrate, an ejection port member is formed, and multiple ejection ports (also referred to as “nozzles”) that eject the inks are disposed in the ejection port member. Further, through-holes that serve as channels for the inks are formed in the substrate, and the inks are supplied from the rear side to the front side of the substrate through the through-holes. The through-holes and the ejection ports communicate with each other, and the inks that have passed through the through-holes are ejected from the ejection ports by forces applied from the energy generation elements. Examples of the energy generation elements include elements that boil the inks via electric heating, such as heater elements, and elements that apply pressure to the liquids by utilizing a volumetric change, such as piezoelectric elements.

Japanese Patent Laid-Open No. 2007-320171 discloses a liquid ejection apparatus as an example of the devices with joined substrates. Specifically, the head of the liquid ejection apparatus has pressure generation chambers communicating with nozzle openings, and piezoelectric elements including electrodes provided in a piezoelectric layer, and liquids in the pressure generation chambers are ejected through the nozzle openings. Generally, in liquid ejection apparatuses as disclosed in Japanese Patent Laid-Open No. 2007-320171, multiple substrates are joined using an adhesive.

Here, when these substrates are joined, the adhesive may protrude toward structures formed in the joined surfaces of the substrates. The protruding adhesive may affect ejection characteristics. For example, if the adhesive greatly protrudes into openings accommodating energy generation elements, such as piezoelectric elements, it may affect the driving of those energy generation elements. In particular, in a case where openings that serve as ink channels are small, they may be easily closed by the adhesive. This will cause troubles such as ink ejection failure.

To address such protrusion of the adhesive, one may consider providing recesses for accommodating an excess adhesive at positions suitable for the opening pattern. For example, one may consider implementing a countermeasure involving providing recesses capable of accommodating the adhesive around the openings accommodating the energy generation elements and the openings serving as ink channels to block the inflow of the adhesive into the openings. However, simply disposing the large recesses to block the adhesive may not be sufficient to thoroughly prevent the occurrence of the troubles.

### SUMMARY

In view of the above problem, an object of the present disclosure is to accurately control the protrusion of an adhesive into openings provided in a substrate of a liquid ejection head.

An embodiment of the present disclosure is a method of manufacturing a liquid ejection head in which a first substrate and a second substrate are joined with an adhesive therebetween, the method including: preparing the first substrate and the second substrate, in at least one of which a first opening that serves as a channel for a liquid and a recess that accommodates part of the adhesive are formed; forming a joint region with the adhesive between the first substrate and the second substrate by joining the first substrate and the second substrate with the adhesive therebetween; and curing the adhesive. The recess is formed to have such a width in a traverse direction of the first substrate and such a width in a longitudinal direction of the first substrate as to satisfy P1≥P3≥P2, where P1 is a pressure generated on a liquid surface being an end surface of the adhesive after the formation of the joint region but before the curing that abuts the channel in the joint region in a case where the adhesive does not protrude from the joint region, P2 is a pressure generated on a liquid surface being an end surface of the adhesive abutting the channel in a case where the adhesive protrudes from the joint region, the liquid surface abutting the channel such that L representing a protrusion length of the adhesive satisfies 1.0H≤L≤1.5H, His a substrate-to-substrate distance between the first substrate and the second substrate in a lamination direction of the first substrate and the second substrate, and P3 is a pressure generated on a liquid surface of the adhesive inside the recess.

Features of the present disclosure will become apparent from the following description of embodiments with reference to the attached drawings. The following description of embodiments is described by way of example.

### BRIEF DESCRIPTION OF THE DRAWINGS

FIGS. 1A to 1C are views illustrating a configuration of a printing apparatus in a first embodiment;

FIG. 2 is a schematic cross-sectional view of a joined substrate in the first embodiment;

FIG. 3 is an explanatory diagram of a pressure P1 generated on the liquid surface of an adhesive at an end portion of a substrate;

FIG. 4 is an explanatory diagram of a pressure P2 generated on the liquid surface of the adhesive protruding from an end portion of a substrate;

FIGS. 5A to 5C are explanatory diagrams of a pressure P3 generated on the liquid surface of the adhesive in a recess;

FIG. 6 is a schematic view of a cross section in the first embodiment;

FIG. 7 is a schematic view of a cross section in the first embodiment;

FIG. 8 is a schematic view of a cross section in the first embodiment;

FIG. 9 is a schematic view of a cross section in the first embodiment;

FIG. 10 is a view illustrating drawing of the adhesive from end portions of a substrate;

FIG. 11 is a schematic cross-sectional view illustrating pressure ranges in the first embodiment;

FIG. 12 is a schematic cross-sectional view illustrating pressure ranges in the first embodiment;

FIG. 13 is a schematic cross-sectional view illustrating pressure ranges in the first embodiment;

FIG. 14 is a view illustrating capillary rise by a recess in the first embodiment;

FIG. 15 is a view illustrating the capillary rise by a recess in the first embodiment;

FIG. 16 is a schematic plan view of a joined substrate;

FIGS. 17A and 17B are schematic cross-sectional views illustrating a method of manufacturing a joined substrate in the first embodiment;

FIGS. 18A to 18D are schematic cross-sectional views illustrating the method of manufacturing a joined substrate in the first embodiment;

FIGS. 19A and 19B are schematic cross-sectional views illustrating the method of manufacturing a joined substrate in the first embodiment;

FIG. 20 illustrates a liquid ejection apparatus having a liquid ejection head manufactured using joined substrates;

FIGS. 21A and 21B are schematic cross-sectional views illustrating the behavior of the adhesive in a recess in the first embodiment;

FIG. 22 is a schematic view of the plan-view shape of a recess in the first embodiment;

FIG. 23 is a schematic view of the plan-view shape of a recess in the first embodiment;

FIG. 24 is a schematic view of the plan-view shape of a recess in the first embodiment;

FIG. 25 is a schematic view of the plan-view shape of a recess in the first embodiment;

FIG. 26 is a schematic view of the plan-view shape of a recess in the first embodiment;

FIGS. 27A and 27B are schematic views of the plan-view shapes of recesses in the first embodiment;

FIGS. 28A and 28B are schematic views of the plan-view shapes of recesses in the first embodiment; and

FIG. 29 is a schematic view of the plan-view shape of a recess in the first embodiment.

### DESCRIPTION OF THE EMBODIMENTS

A preferred embodiment of the present disclosure will be described below with reference to the drawings. Note that in the embodiment to be described below, a specific description will be provided to sufficiently describe the present disclosure, but this merely presents one technically preferable example and is not intended to unnecessarily limit the scope of the present disclosure. For example, unless otherwise noted, the dimensions, materials, and shapes of the components described in the following embodiment and their relative arrangements and the like are not intended to limit the scope of the present disclosure solely to those. Also, in the following embodiment, joining of two or three substrates will be described by way of example, but the present disclosure is not limited to this. The technology of the present disclosure is applicable to cases of joining multiple substrates.

Note that unless otherwise noted, the material, shape, and the like of each member set forth once in the following description shall be regarded as similar in the subsequent description.

### First Embodiment

A substrate for a liquid ejection head in a first embodiment will be described below.

### Configuration of Printing Apparatus

Liquid ejection heads are members included in a printing apparatus, such as an inkjet printer. In addition to the liquid ejection heads, such a printing apparatus is provided with a liquid storage unit that stores liquids to be supplied to the liquid ejection heads, a conveyance mechanism that conveys print media on which to print images, and so on.

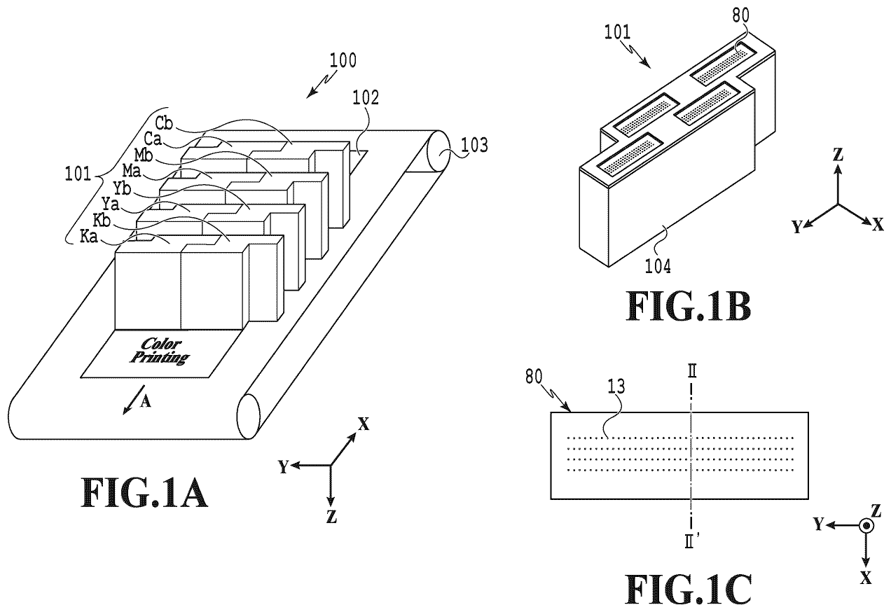

FIG. 1A is a view schematically illustrating a printing apparatus 100 representing an example of a liquid ejection apparatus in the present embodiment. The printing apparatus 100 has one-pass liquid ejection head modules 101 (hereinafter referred to as “liquid ejection heads”) that print an image on a print medium 102 while moving the print medium 102 once. Ejection ports (referred to also as “nozzles”) are arrayed in the liquid ejection heads 101 over a length corresponding to the entire width of the print medium 102. The liquid ejection heads 101 in the present embodiment are heads for four colors of cyan (C), magenta (M), yellow (Y), and black (K) and, in FIG. 1A, denoted by Ka, Kb, Ya, Yb, Ma, Mb, Ca, and Cb, respectively. Thus, in the printing apparatus 100, two liquid ejection heads are provided for each ink color. The print medium 102 is conveyed in the direction of an arrow A by a conveyance unit 103, and the print medium 102 by thus conveyed is subjected to image printing involving ink ejection by the liquid ejection heads 101. Note that the printing apparatus 100 illustrated in FIG. 1A is a mere example, and may be configured such that one or more liquid ejection heads in any form are mountable thereon. For example, the printing apparatus 100 may have only one type of liquid ejection head or multiple types of liquid ejection heads other than the four types.

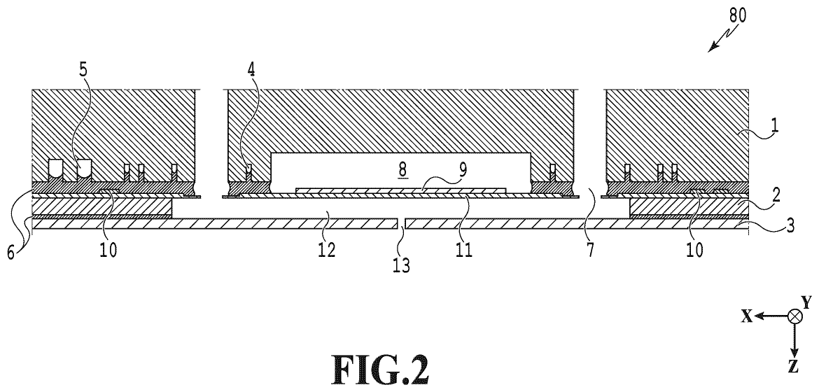

The coordinate axes are defined as illustrated in FIG. 1A. Specifically, the width direction of the print medium is the Y direction, the direction of gravity (also referred to as “height direction”) is the Z direction, and the direction orthogonal to the Y and Z directions is the X direction. The direction of the arrow A, in which the print medium 102 is conveyed, is the −X direction. These coordinate axes are similarly used in other drawings as needed. These coordinate axes are such that the X direction is the traverse direction of substrates and the Y direction is the longitudinal direction of the substrates, as illustrated in FIGS. 1B and 1C, and the Z direction is the lamination direction of the substrates, as shown in FIG. 2 and subsequent drawings. Note that the X direction may be the longitudinal direction of the substrates, and the Y direction may be the traverse direction of the substrates.

### Configuration of Liquid Ejection Head

FIG. 1B is a view describing a liquid ejection head 101 in the present embodiment and is a perspective view of any one liquid ejection head for any one color among the multiple liquid ejection heads illustrated in FIG. 1A. As illustrated in FIG. 1B, the liquid ejection head 101 has a head main body 104. In the head main body 104, multiple liquid ejection substrates each of which is formed to include a joined substrate 80 are disposed. In the example of FIG. 1B, four liquid ejection substrates are disposed. Each liquid ejection substrate includes multiple ejection ports 13 (see FIG. 1C). The ink to be ejected from the liquid ejection head is supplied to the liquid ejection substrates from an ink tank (not illustrated) through a common supply port (not illustrated) in the head main body 104. As illustrated in FIG. 1B, the four liquid ejection substrates are disposed along the Y direction, and the two liquid ejection substrates in closest proximity to each other in the Y direction are arranged at different positions in the X direction. In this way, the ejection ports 13 of one liquid ejection substrate (first liquid ejection substrate) at one portion (an end portion in the Y direction) and the ejection ports 13 of the liquid ejection substrate in closest proximity to the first liquid ejection substrate in the Y direction (second liquid ejection substrate) at one portion (an end portion in the Y direction) are located at the same position in the Y direction. Arranging the multiple liquid ejection substrates in this manner enables printing with long ejection port arrays.

FIG. 1C is a plan view of a liquid ejection substrate as seen from the ejection ports 13 side.

FIG. 2 is a schematic cross-sectional view of the joined substrate 80 taken along the cross-sectional line II-II′ illustrated in FIG. 1C. Note that FIG. 2 is a schematic view of a region including a single ejection port, and effects of an adhesive flowing into openings is not illustrated. Incidentally, in this specification, the openings may be referred to also as “opening portions.”

The joined substrate 80 includes a first substrate 1, a second substrate 2, and a third substrate 3. The first and second substrates 1 and 2 are joined with an adhesive 6, and the second and third substrates 2 and 3 are joined with an adhesive 6. Thus, each joined substrate in the present embodiment has at least one joint surface formed of an adhesive (in the example of FIG. 2, the joined substrate 80 has two joint surfaces).

The first substrate 1 is formed of, for example, a silicon substrate and has a structure including a vibration film 11 and piezoelectric elements 9 formed thereon. In the second substrate 2, openings that form pressure chambers 12 are formed. The vibration film 11 defines multiple pressure chambers 12 by forming the top walls of the pressure chambers 12. Further, in the first substrate 1, first openings 7 for supplying a liquid to the pressure chambers 12, second openings 8, and the like are formed.

An upper portion of the joined substrate 80 is formed by joining the first and second substrates 1 and 2 with an adhesive 6 therebetween. Here, the first and second openings 7 and 8 are formed in the first substrate 1, and the pressure chambers 12 are formed in the second substrate 2. Also, in the second openings 8, the piezoelectric elements 9 are accommodated such that they correspond respectively to the multiple pressure chambers 12. Note that, as illustrated, the positions, in the X direction, of end surfaces in the first substrate 1 abutting ink channels and the positions, in the X direction, of end surfaces in the second substrate 2 abutting the ink channels are different.

The third substrate 3 is formed of, for example, a silicon substrate and ejection ports 13 that ejects the liquid are formed therein. The ejection ports 13 communicate with the pressure chambers 12 and penetrate through the third substrate 3. Thus, changing the inner volume of a pressure chamber 12 will eject the liquid in the pressure chamber 12 from the corresponding ejection port 13.

In the first substrate 1, first recesses 4 and second recesses 5 are formed. The ink tank (not illustrated) is disposed on the first substrate 1. Moreover, the first openings 7 are formed to penetrate through the first and second substrates 1 and 2 and communicate with the pressure chambers 12. Thus, the liquid inside the ink tank is supplied to the pressure chambers 12 through the first openings 7.

Piezoelectric actuators are constructed by disposing the piezoelectric elements 9 on the vibration film 11. These piezoelectric actuators each include a lower electrode (not illustrated) formed on a vibration film forming layer, a piezoelectric element 9 formed on the lower electrode, and an upper electrode (not illustrated) formed on the piezoelectric element 9.

The vibration film forming layer is formed by plasma chemical vapor deposition (CVD), for example. Then, a hydrogen barrier film (not illustrated), the lower electrode (not illustrated), a piezoelectric film, and the upper electrode (not illustrated) are sequentially formed. The lower and upper electrodes are formed by a sputtering method, for example, and the piezoelectric film is formed by a sol-gel method but may be formed by a sputtering method.

As each piezoelectric element 9, a lead zirconate titanate (PZT) film formed by a sol-gel method or a sputtering method, for example, can be used. Such piezoelectric elements 9 are made of sintered metal oxide crystals. An actuator substrate can be formed by forming an inter-layer film and wirings 10 such that actuator portions can be driven. The wirings 10 are connected to piezoelectric actuators.

Each piezoelectric element 9 is formed at a position facing the corresponding pressure chamber 12 with the vibration film 11 therebetween. Specifically, each piezoelectric element 9 is formed in contact with the surface of the vibration film 11 on the opposite side from the corresponding pressure chamber 12. The vibration film 11 has such a property that it can deformed in the direction toward the pressure chambers 12. In response to application of a drive voltage to the piezoelectric elements 9 through the wirings 10 from an integrated chip (IC) for driving (not illustrated), the piezoelectric elements 9 get deformed by an inverse piezoelectric effect. As a result, the vibration film 11 gets deformed along with the piezoelectric elements 9. This in turn changes the inner volumes of the pressure chambers 12 and pressurizes the liquid. The pressurized liquid is ejected from the ejection ports 13 in the form of fine droplets.

The openings and the recesses in the present embodiment will be described below. When the second substrate 2 is joined to the first substrate 1 with an adhesive 6 therebetween, the adhesive may close the first openings 7 formed as ink channels in the joint surface and protrude into the second openings 8 accommodating the piezoelectric elements 9, thereby adversely affecting the liquid ejection.

Variation in the application and transfer of the adhesive 6 to the first substrate 1 makes this adverse effect severe especially in a case where the adhesive 6 is required in a plentiful amount to fill the steps formed by the wirings 10 disposed in the joint surface between the first and second substrates 1 and 2 and in a case where the joint surface is long and requires a large amount of the adhesive.

The inventors of the present application have found that the size of protrusion of the adhesive can be controlled to be within a certain range by controlling the size of the recesses for these openings within the range of a joint region and curing the adhesive after the adhesive reaches equilibrium at a temperature at which the adhesive flows. Note that the “equilibrium” here refers to a state where the adhesive moves and the pressure generated on the shape of its liquid surface in the present embodiment falls and is maintained within a predetermined range.

In the following, pressures that are generated on end portions of the shape of the liquid surface of the adhesive in the present embodiment will be described. Note that the shape of the liquid surface of the adhesive on a substrate in the present embodiment is so small that the effect of gravity thereon can be ignored, and thus the effect of gravity is not taken into account here. Also, the shapes of end portions of the shape of the liquid surface of the adhesive refers to, for example, the shape of the liquid surface of the adhesive formed at end portions of the first substrate 1, in particular, end portions of the first openings 7.

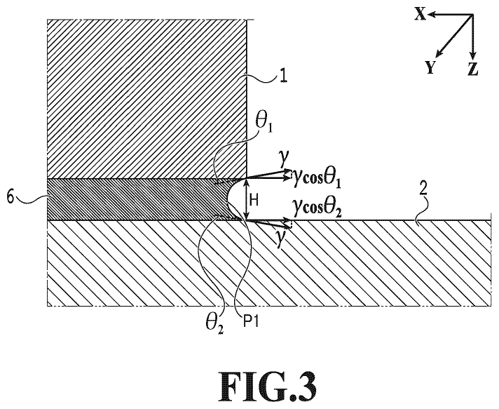

First, details of the calculation of equilibrium between a pressure P1 and a surface tension generated on a liquid surface formed by an end surface of the adhesive in the joint region between the first and second substrates 1 and 2 will be described using FIG. 3. Note that the joint region refers to a region made with the adhesive spreading in the X and Y directions between the first and second substrates 1 and 2, and also has a length in the Z direction. The joint region is substantially equivalent to the joint surface mentioned earlier but refers in particular to a region that fits within the XY plane of the first substrate 1. Also, the pressure P1 means a pressure that is generated on a liquid surface being an end surface of the adhesive abutting a channel in the joint region between the first and second substrates 1 and 2 in a case where the adhesive fits within the joint region after a process of forming the joint region but before a process of curing the adhesive. Note that the wording “the adhesive fits within” means that the adhesive does not protrude from the joint region.

Assuming that the surface tension of the adhesive is γ, this surface tension γ acts at contact angles θ1 and θ2 with respect to the first and second substrates 1 and 2, respectively. The surface tension along the contact lines is represented by Equation (1).

$$γ ( cos θ1 + cos θ 2 ) \times y ( depth ) \qquad Equation ( 1 )$$

Note that the term “contact line” used herein means the length of a one-dimensional region where the force acts (circumferential length).

On the other hand, the resultant pressure P1 that is generated on the liquid surface formed by the end surface of the adhesive is defined by Equation (2), in which H is the distance (Z-direction distance) across the joint surface between the first and second substrates 1 and 2 at the end surface of the adhesive and approximated such that the length of the liquid surface in the Z direction≈H.

$$P 1 \times H \times y ( depth ) \qquad Equation ( 2 )$$

The value calculated by Equation (1) and the value calculated by Equation (2) are equal. Thus, the pressure P1 that is generated on the end surface of the adhesive in the joint region between the first and second substrates 1 and 2 is defined by Equation (3).

$$P 1 = γ ( cos θ 1 + cos θ 2 ) / H \qquad Equation ( 3 )$$

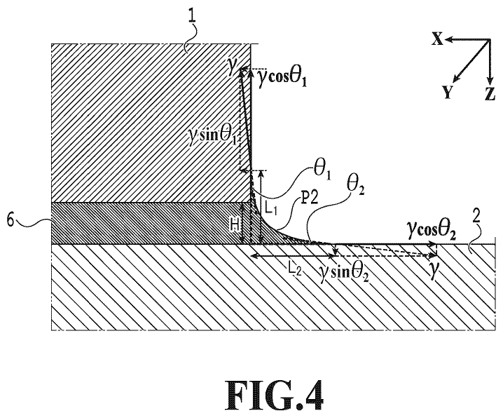

Next, details of the calculation of equilibrium between a pressure P2 and a surface tension generated on a liquid surface formed as a portion of the adhesive protruding from the joint region between the first and second substrates 1 and 2 will be described using FIG. 4. Note that the pressure P2 means a pressure that is generated on a liquid surface being the end surface of the adhesive abutting a channel in a case where the adhesive protrudes from the joint region between the first and second substrates 1 and 2 after the process of forming the joint region but before the process of curing the adhesive.

Assuming that the surface tension of the adhesive protruding from an end portion of the first substrate 1 is γ, this surface tension γ acts at contact angles θ1 and θ2 with respect to the first and second substrates 1 and 2, respectively. The surface tension along the contact lines is represented by Equations (4) and (5) on the assumption that the surface tension is decomposed into a component in the X direction and a component in the Z direction as follows.

$$X direction : γ ( cos θ 2 - sin θ 1 ) \times y ( depth ) \qquad Equation ( 4 )$$

$$Z direction : γ ( cos θ 1 - sin θ 2 ) \times y ( depth ) \qquad Equation ( 5 )$$

That is, the surface tension along the contact lines is the sum of the value calculated by Equation (4) and the value calculated by Equation (5), and is represented by Equation (6).

$$γ ( cos θ 1 + cos θ 2 - sin θ 1 - sin θ 2 ) \times y \qquad Equation ( 6 )$$

On the other hand, the resultant pressure P2 that is generated on the liquid surface formed by the protrusion is defined by Equation (7), in which L1 is the length of protrusion into the first substrate 1, L2 is the length of protrusion onto the second substrate 2, and the length of the liquid surface in the Z direction is approximated as L1+L2 (≈L1+L2).

$$P 2 ( L 1 + L 2 ) \times y ( depth ) \qquad Equation ( 7 )$$

The value calculated by Equation (6) and the value calculated by Equation (7) are equal. Thus, the pressure P2 that is generated on the protrusion of the adhesive at an end portion of the first substrate 1 in the joint surface between the first and second substrates 1 and 2 is defined by Equation (8).

$$P 2 = γ ( cos θ 1 + cos θ 2 - sin θ 1 - sin θ 2 ) / ( L 1 + L 2 ) \qquad Equation ( 8 )$$

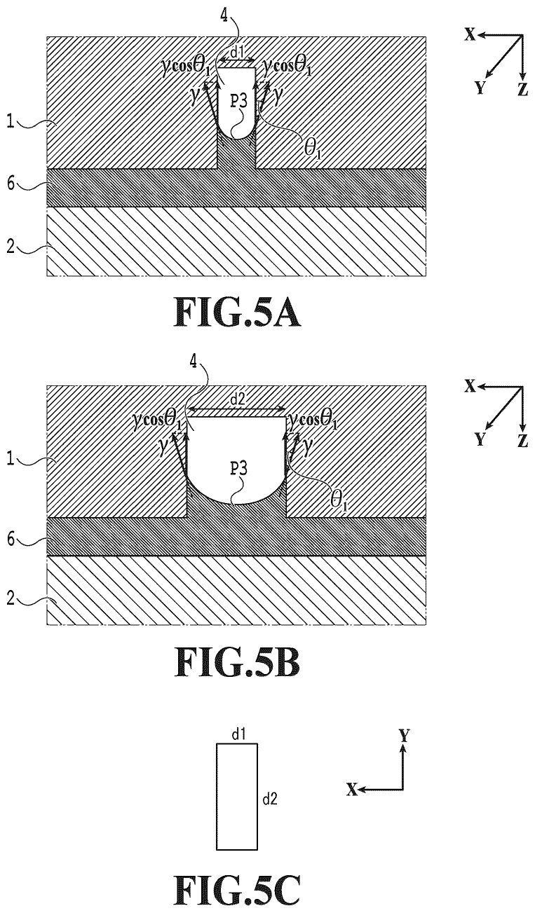

Next, details of the calculation of equilibrium between a pressure and a surface tension generated on the liquid surface of the adhesive in a first recess 4 in the joint region between the first and second substrates will be described using FIGS. 5A to 5C.

As illustrated in FIGS. 5A to 5C, each first recess 4 is formed to have an X-direction width d1 and a Y-direction width d2. Note that FIGS. 5A and 5B illustrate an example in which the first recess 4 is formed in the first substrate 1, but the position is not limited to this and each first recess 4 may be formed in the second substrate 2, for example. Also, the plan-view shape (the shape in a plane parallel to the joint surface) of each recess may be elliptical or polygonal, instead of a rectangular shape.

Assuming that the surface tension of the adhesive is γ, this surface tension γ acts at a contact angle θ1 with respect to the first substrate 1 in a case where the first recess 4 is formed in the first substrate 1, for example. Thus, the surface tension along the contact line is represented by Equation (9).

$$γ cos θ 1 \times 2 ( d 1 + d 2 ) \qquad Equation ( 9 )$$

On the other hand, the resultant pressure P3 generated on the liquid surface inside the recess is defined by Equation (10), in which the length of the liquid surface in the X direction is approximated as d1 (≈d1) and the length of the liquid surface in the Y direction is approximated as d2 (≈d2).

$$P 3 \times d 1 \times d 2 \qquad Equation ( 10 )$$

The value calculated by Equation (9) and the value calculated by Equation (10) are equal. Thus, based on these equations, the pressure P3 that is generated in the recess in the joint region between the first and second substrates 1 and 2 is defined by Equation (11).

$$P 3 = 2 γ cos θ 1 ( d 1 + d 2 ) / d 1 d 2 \qquad Equation ( 11 )$$

Here, it is generally preferable that the adhesive is in a state where it sufficiently wets the surface from the viewpoint of adhesion, and the substrate is subjected to a surface modification via surface treatment as needed or a thin film with a similar surface free energy to that of the adhesive or the like is formed as needed. Further, by applying heat during or after the joining to accelerate the curing reaction of the adhesive, the cohesive energy of the adhesive molecules decreases, thus reducing the surface tension of the adhesive and making the difference between the surface tensions at the contact lines on the first and second substrates 1 and 2 small. Hence, in the present embodiment, θ≈θ1≈θ2 and L≈L1≈L2. That is, P1 in Equation (3), P2 in Equation (8), and P3 in Equation (11) can be redefined with Equations (12), (13), and (14), respectively.

$$P 1 = 2 γcos θ / H \qquad Equation ( 12 )$$

$$P 2 = γ ( cos θ - sin θ ) / L \qquad Equation ( 13 )$$

$$P 3 = 2 γ cos θ ( d 1 + d 2 ) / d 1 d 2 \qquad Equation ( 14 )$$

These are pressures each generated on the shape of a liquid surface at an end surface of the adhesive in a liquid state, but the shape of the liquid surface of the adhesive will be maintained even after the adhesive is cured. The shape of the liquid surface of the adhesive in equilibrium is the shape immediately before the curing. Hence, each pressure generated on the shape of the liquid surface of the adhesive in the liquid state can be calculated afterwards based on the shape after the curing.

By using the values of these pressures, the protrusion at the first openings 7 is controlled based on the size of the first recesses 4. Specifically, the first recesses 4 are formed to have such an X-direction width d1 and Y-direction width d2 that P1≥P3≥P2 will be satisfied as a preferable range of P3 in the present embodiment.

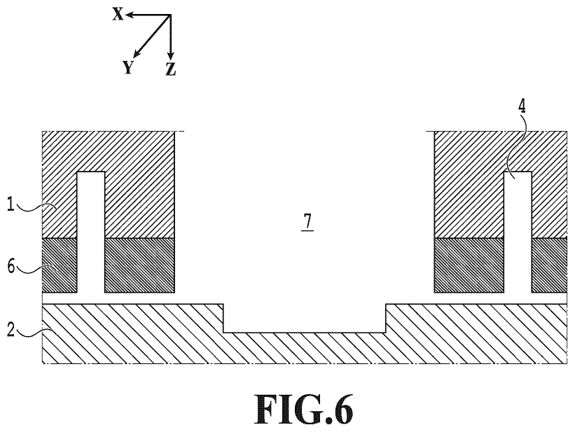

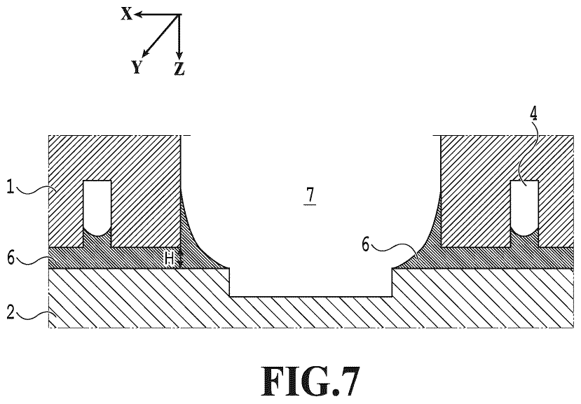

FIG. 6 is a schematic view of a state where an adhesive 6 has been transferred to the first substrate 1. FIG. 7 is a schematic view of a state where the first and second substrates 1 and 2 are joined from the state illustrated in FIG. 6 with a distance H left therebetween in the Z direction. Here, as illustrated in FIG. 7, the adhesive 6 greatly protrudes at least into openings formed by end surfaces of the first substrate and the second substrate (first openings 7). The adhesive 6 in this state at least has fluidity, so that the adhesive 6 gets drawn into the first recesses 4 provided in the first substrate 1 by the pressure P3 generated as a result of the formation of liquid surfaces on the adhesive 6 in the first recesses 4.

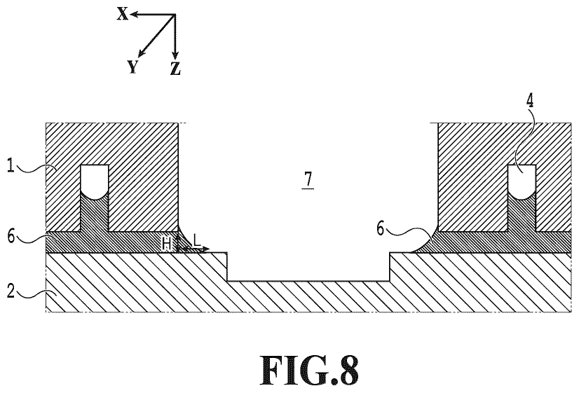

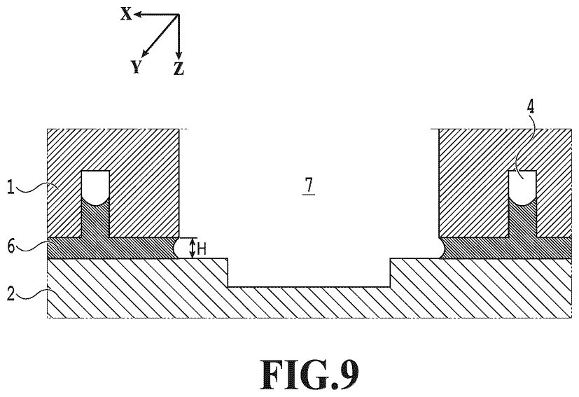

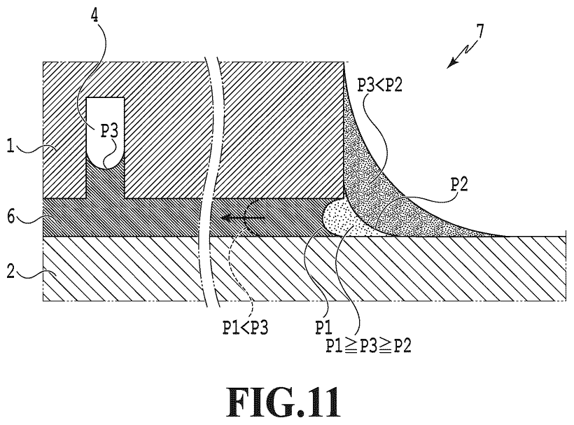

In the process in which the adhesive 6 gets drawn into recesses, such as the first recesses 4, the adhesive 6 flows until the pressure P1 or P2 generated on the shape of the liquid surface of the adhesive 6 and the pressure P3 generated on the shape of the liquid surface in the recesses become equal to each other (see FIG. 11). For example, the adhesive 6 flows until assuming a shape as illustrated in FIG. 8 or 9.

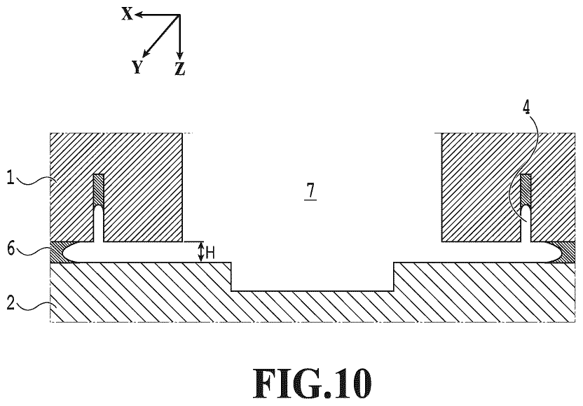

The outgassing that occurs inside the recesses during the adhesive curing process and the like may raise the internal pressures of the recesses. Even in this case, a high pressure P3 provides a surface tension stronger than that raised internal pressure, thus preventing the adhesive from flowing out of the recesses. Hence, it is preferable that the pressure P3 be high. However, if the pressure P3 is excessively high, in particular P1<P3, then the pressure P3 generated on the shapes of the liquid surfaces in the recesses will be higher than the pressure P1 generated on the shapes of the liquid surfaces at opening ends. Thus, the adhesive will continue to be drawn into the recesses, and the end portions of the adhesive will continue to retract from the openings. Consequently, the adhesive 6 will cure in a state where the end portions of the adhesive 6 have greatly retracted from the end portions of the first substrate 1 and have formed voids, as illustrated in FIG. 10, for example. For this reason, the first recesses 4 need to be formed such that at least P1≥P3 is satisfied.

The pressure P1 generated on the liquid surface of the adhesive 6 illustrated in FIG. 9 is defined by Equation (12). In a case where the distance H between the first and second substrates 1 and 2 (the length of the joint surface in the Z direction, referred to also as “substrate-to-substrate distance”) at end portions of the joint surface made of the adhesive is small (short), the flow resistance in the process in which the adhesive flows will be high, making it difficult for the adhesive to flow. Also, for the purpose of filling the steps formed by the wirings and preventing or reducing formation of voids during the joining, it is preferable that the distance H have a certain length and, in particular, the distance H be more than or equal to 1.5 μm. Also, in a case where the substrate-to-substrate distance is long, the outgassing from the adhesive having entered the recesses and the like make it easier for the adhesive to move. For this reason, the distance H is preferably 5.0 μm or less and more preferably 4.0 μm or less.

How to control the thickness of the adhesive is not particularly limited. The thickness can be controlled relatively accurately by forming a protruding portion having a known height on either substrate or by mixing a filler having a known size with the adhesive.

Also, while the pressure P2 generated on the liquid surface of the adhesive 6 protruding from the first substrate 1 as illustrated in FIG. 8 is defined by Equation (13), it is preferable that the width L of the protrusion be relatively short, in particular, a value within the range of 1.0H≤L≤1.5H. In the present embodiment, H=1.5L. Note that H=1.0L is most preferable.

If the recesses are formed based settings as described above and the pressures P2 and P3 calculated from the respective shapes after the curing indicate that P2>P3, it is possible that the curing reaction of the adhesive progressed before equilibrium was reached, thereby lowering the fluidity and resulting in failure to control the protrusion to the desired size.

From the reasons described above, in the present embodiment, the pressures P1 to P3 generated on the liquid surfaces of the adhesive 6 at the first openings 7 formed by end portions of the first substrate 1 and the second substrate 2 and in the first recesses 4 are such that the range of these pressures is preferably P1≥P3≥P2. FIG. 11 is a view illustrating this range.

Also, Table 1 lists differences between the pressures P1 and P2 (P1−P2), where the pressure P1 is calculated from the substrate-to-substrate distance H in the present embodiment, and the pressure P2 is calculated with the length L of protrusion of the adhesive being equal to 1.0H(L=1.0H) and 1.5 H(L=1.5H). Table 1 indicates that, as the value of the substrate-to-substrate distance H increases, the difference between the pressures P1 and P2 decreases and the range from which the pressure P3 can be selected decreases, that is, the amount of freedom in the shape of the recesses decreases. In view of this, the substrate-to-substrate distance H is preferably less than or equal to 5.0 μm, which ensures a difference of about 5000 Pa between the pressures P1 and P2, and more preferably less than or equal to 4.0 μm, which ensures a difference of about 6000 Pa.

TABLE 1

| | | L (μm) ※L = 1.0H | | |
|---|---|---|---|---|
| H (μm) | P1(Pa) | L (μm) ※L = 1.5H | P2(Pa) | P1 − P2 (Pa) |
| 1.5 | 25758 | 1.5 | 9428 | 16330 |
| | | 2.25 | 6285 | 19473 |
| 2.0 | 19319 | 2.0 | 7071 | 12247 |
| | | 3.0 | 4714 | 14605 |
| 3.0 | 12879 | 3.0 | 4714 | 8165 |
| | | 4.5 | 3143 | 9736 |
| 4.0 | 9659 | 4.0 | 3536 | 6124 |
| | | 6.0 | 2357 | 7302 |
| 5.0 | 7727 | 5.0 | 2828 | 4899 |
| | | 7.5 | 1886 | 5841 |

Here, in a case where the shape of a liquid surface formed as the end surface of the adhesive 6 at an end portion of the first substrate 1 is maintained by the pressure P1 generated on the liquid surface when the adhesive within the region from P2 to P1 (the dotted region in FIG. 11) is drawn in by the first recesses 4, the shape in the FIG. 8 is obtained. On the other hand, in a case where the pressure P3 generated in the recesses exceeds the pressure P1 generated on the liquid surface formed as the end surface of the adhesive on the substrate 1 in the process of drawing the adhesive into the recesses or the process of curing the adhesive, the liquid surface shifts toward the shape in FIG. 9.

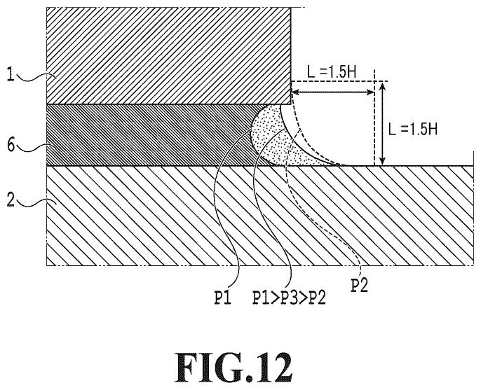

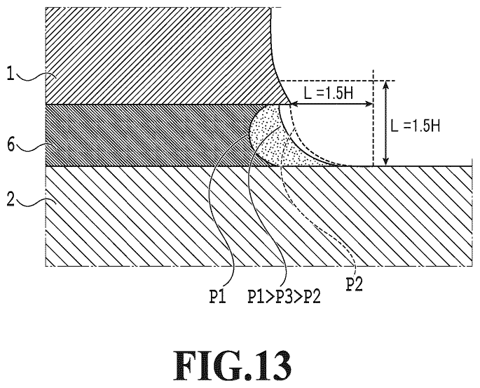

Thus, a shape that satisfies P1≥P3≥P2 as the range of the pressure P3 in the present embodiment includes the protruding shape within the range surrounded by P1 and P2 illustrated in FIG. 11. For example, a shape as illustrated in FIG. 12 is included. Also, a shape as illustrated in FIG. 13, for example, in which the first substrate 1 has a different etching shape, is included as well.

Also, in a case of transferring the adhesive, the adhesive is not transferred into the recesses. Accordingly, an effect of reducing the adhesive in advance can also be expected. Thus, in addition to the first recesses 4 provided outside the openings to be used as ink channels and the portions to accommodate the piezoelectric elements, one or more second recesses 5 that differ from the first recesses 4 at least in X-direction width or Y-direction width may be disposed. In that case, the effect of the present embodiment can be achieved by forming the recesses such that P1≥P4≥P2, where P4 is the highest pressure among the pressures on the shapes of the liquid surfaces formed in the first recesses 4 and the liquid surfaces formed in the second recesses 5. Incidentally, in the present embodiment, there are two types of recesses, namely the first and second recesses 4 and 5, but there may be three or more types. Also, the first and second recesses 4 and 5 may have different plan-view shapes (a cross-sectional shape in the X and Y directions).

In a case where the first recesses 4 are located far in distance from the corresponding first opening 7, there is a possibility that the friction of the fluid (the adhesive in the liquid state) on the walls of the first and second substrates 1 and 2 imposes a significant impact in the process in which the adhesive flows. For this reason, it is preferable that the distance be short between the first recesses 4 and the corresponding first opening 7. In the present embodiment, it is preferable that the first recesses 4 be disposed at a distance of 100 μm or less from the corresponding first opening 7.

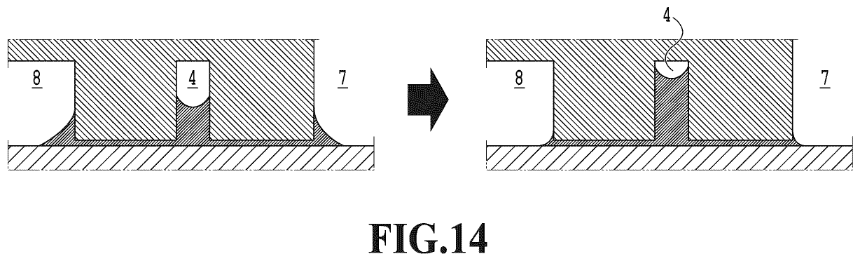

The positions of the first recesses 4 are not particularly limited. For example, as illustrated in FIGS. 2 and 14, the first recessed portions 4 can be disposed between the first openings 7 and the second openings 8 (closed spaces) for accommodating the piezoelectric actuators. Also, in FIG. 2, first recessed portions 4 can be disposed between the first opening 7 connected to the pressure chamber 12 corresponding to the illustrated piezoelectric actuator and the first opening (not illustrated) connected to the pressure chamber (not illustrated) corresponding to a different piezoelectric actuator (not illustrated) from the illustrated piezoelectric actuator.

Each first recess 4 in the present embodiment is disposed as illustrated in FIG. 14. With this arrangement, the pressure P3 generated on the liquid surface of the adhesive 6 in the first recess 4 and the pressure generated on the liquid surface of the adhesive in the first opening 7 after the adhesive 6 has finished flowing are equal to each other in a steady state. Also, in this case, the pressure P3 and the pressure generated on the liquid surface of the adhesive in the second opening 8 for accommodating a piezoelectric actuator are equal to each other in the steady state.

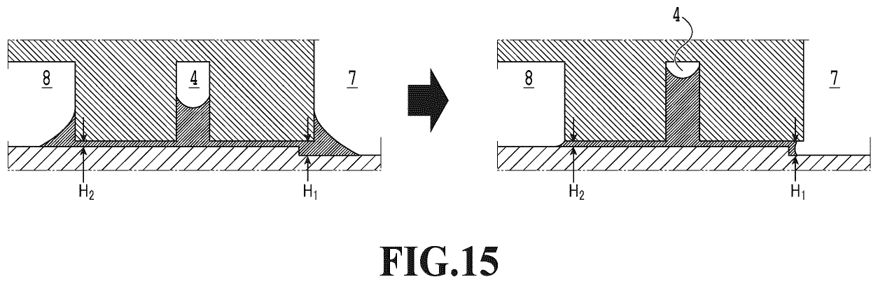

As illustrated in FIG. 15, for example, the substrate-to-substrate distance (the length of the joint surface in the Z direction) may be different between a side close to a first opening 7 and a side close to the corresponding second opening 8 (see H1 and H2 in FIG. 15). By making the substrate-to-substrate distance H1 on the side close to the first opening 7 long, the amount of protrusion of the adhesive can be made small. Also, it is preferable that the substrate-to-substrate distance H2 on the side close to the second opening 8 be short because there is a possibility that the adhesive may get pushed out into a closed space like the second opening 8 by a rise in internal pressure due to the outgassing from the adhesive and form a void. In the case where the substrate-to-substrate distance H2 is short, the pressure P1 to be generated on the liquid surface of the adhesive in the second opening 8 will be high. This makes it possible to prevent or reduce formation of a void as mentioned above.

Also, multiple first openings 7 with different sizes may be disposed in the substrate. Moreover, the substrate-to-substrate distance around each of those first openings 7 may be made different according to the size of that opening in an XY plane.

Here, a relation 2γ cos θ/H≥2γ cos θ(d1+d2)/d1d2≥γ(cos θ−sin θ)/L can be derived from the above-mentioned relation P1≥P3≥P2. This relation can be organized using the relation L=H, which is the most preferable condition in the present embodiment, to derive a relation 1≥H(d1+d2)/d1d2≥(cos θ−sin θ)/2 cos θ.

In view of the wettability of the adhesive, it is preferable to set the widths d1 and d2 of each recess in relation to the substrate-to-substrate distance H at an opening end such that the ranges of 0≤35° and 1≥H(d1+d2)/d1d2≥0.15 (i.e., 1≥H(1/d1+1/d2)≥0.15) are satisfied. Further, it is more preferable to set the widths d1 and d2 of each recess in relation to the substrate-to-substrate distance H at an opening end such that the ranges of 0≤30° and 1≥H(d1+d2)/d1d2≥0.21 (i.e., 1≥H(1/d1+1/d2)≥0.21) are satisfied. Furthermore, in this case, it is preferable that H be 1.5 μm or more and 4.0 μm or less.

For example, in a case where H=3.0, d1=10 μm, and d2=10 μm, H(d1+d2)/d1d2=0.6, so that the widths of the recesses and the substrate-to-substrate distance satisfy the above relation, making it possible to control the protrusion of the adhesive.

Hereinabove, a case where the plan-view shape of the recesses is a rectangular shape as illustrated in FIG. 5C has been described, but the present embodiment is applicable to cases where the plan-view shape is other than a rectangular shape. Assuming that the contact line on the wall of a recess having any plan-view shape is γ cos θ, the entire circumference of the recess is D, and the area of the plan-view shape is S, a force F that acts on the entire circumference can be represented as F=Dγ cos θ. Since P=F/S, the pressure P3 that acts on a meniscus in a recess with a plan-view shape within a range within which the effect of the present disclosure can be achieved may be calculated via approximation using P3≈Dγ cos θ/S.

Here, a relation 2γ cos θ/H≥Dγ cos θ/S≥γ(cos θ−sin θ)/L can be derived from the above-mentioned relation P1≥P3≥P2. This relation can be organized using the relation L=H, which is the most preferable condition in the present embodiment, to drive a relation 1≥HD/2S≥(cos θ−sin θ)/2 cos θ.

In view of the wettability of the adhesive, it is preferable to set the plan-view shape of each recess in relation to the substrate-to-substrate distance H at an opening end such that the ranges of 0≤35° and 1≥HD/2S≥0.15 are satisfied. Further, it is more preferable to set the shape of each recess in relation to the substrate-to-substrate distance H at an opening end such that the ranges of 0≤30° and 1≥HD/2S≥0.21 are satisfied. Furthermore, in this case, it is preferable that H be 1.5 μm or more and 4.0 μm or less.

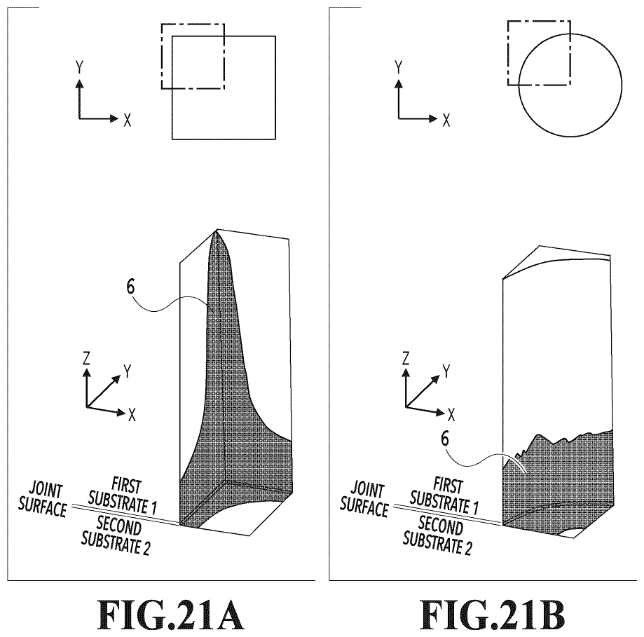

Now, some calculation examples for representative plan-view shapes will be described. In a case where the plan-view shape is a rectangular shape as in FIG. 5C or a polygonal shape, the adhesive creeps more easily along the corner portions. For example, in FIG. 21A, which illustrates a corner portion of a rectangular shape, the adhesive 6 creeps along the corner portion. This makes it possible to accelerate the introduction of the adhesive into the recess.

The following is a specific example of a case where the plan-view shape is a polygonal shape other than that in FIG. 5C. Assuming that the length of one side of an n-gonal plan-view shape of a recess is a1, a2, . . . , and an, and the area of each region formed by lines connecting the center and adjacent vertices of the plan-view shape is S1, S2, . . . , and Sn,

$$D = a 1 + a 2 + … + an = {\sum }_{i = 1}^{n} ai and S = S 1 + S2 + … + Sn = {\sum }_{i = 1}^{n} Si .$$

Thus, the pressure P3 is represented as

$$P3 = {\sum }_{i = 1}^{n} ai γcosθ / {\sum }_{i = 1}^{n} Si .$$

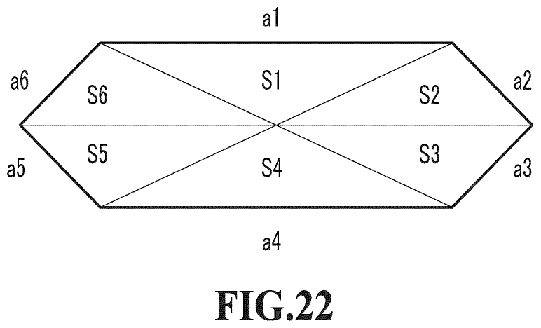

FIG. 22 illustrates a case with a hexagonal shape as an example of the case where the plan-view shape is a polygonal shape as above. Note that the polygonal shape is not limited to this. Also, the n-gonal shape may be a regular n-gonal shape.

In view of the above-mentioned relation P1≥P3≥P2 and the wettability of the adhesive, it is preferable to set the plan-view shape such that 0≤35° and 1≥HD/2S≥0.15. Also, based on the above-mentioned equation, it is preferable to set the plan-view shape of each recess in relation to the substrate-to-substrate distance H at an opening end such that the range of

$$1 \geq H {\sum }_{i = 1}^{n} a i / 2 {\sum }_{i = 1}^{n} Si \geq 0.15$$

is satisfied. Further, it is more preferable to set the shape of each recess in relation to the substrate-to-substrate distance Hat an opening end such that the range of θ≤30° and the range of

$$1 \geq H {\sum }_{i = 1}^{n} a i / 2 {\sum }_{i = 1}^{n} Si \geq 0.21$$

based likewise on the above-mentioned equation are satisfied. Furthermore, in this case, it is preferable that H be 1.5 μm or more and 4.0 μm or less.

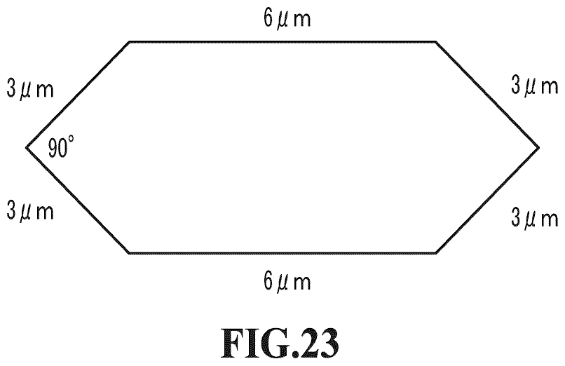

For example, with a hexagonal shape as illustrated in FIG. 23 taken as an example, H=2.0 μm, D=24 μm, and S=34.46 μm², so that HD/2S=0.696. Accordingly, the widths of the recess and the substrate-to-substrate distance satisfy the above-mentioned relation. This makes it possible to control the protrusion of the adhesive.

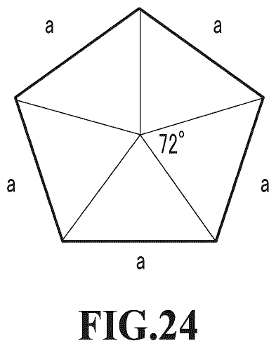

Further, the above-mentioned equation may be used for a regular n-polygonal shape with one side having a length of a but, for n≥4, D=na and S=na2/4 tan(180/n) since the angle formed by straight lines connecting the center and adjacent vertices of the plan-view shape is) 360/n(°). Therefore, the pressure P3 can be represented as P3=4γ cos θ tan(180/n)/a. Note that FIG. 24 illustrates a regular pentagonal shape by way of example, and the n-gonal shape is not limited to this.

In view of the above-mentioned relation P1≥P3≥P2 and the wettability of the adhesive, it is preferable to set the plan-view shape such that 0≤35° and 1≥HD/2S≥0.15. Also, based on the above-mentioned equation, it is preferable to set the plan-view shape of each recess in relation to the substrate-to-substrate distance H at an opening end such that the range of 1≥2H tan(180/n)/a≥0.15 is satisfied. Further, it is more preferable to set the shape of each recess in relation to the substrate-to-substrate distance H at an opening end such that the range of 0≤30° and the range of 1≥2H tan(180/n)/a≥0.21 based likewise on the above-mentioned equation are satisfied. Furthermore, in this case, it is preferable that H be 1.5 μm or more and 4.0 μm or less.

For example, with a regular pentagonal shape as illustrated in FIG. 24 with a=6 μm taken as an example, 2H tan(180/n)/a=0.727 if H=3.0 μm. Accordingly, the widths of the recess and the substrate-to-substrate distance satisfy the above-mentioned relation. This makes it possible to control the protrusion of the adhesive.

Incidentally, the shapes of the corner portions of the rectangular shape in FIG. 5C and polygonal shapes as illustrated in FIGS. 22 and 24 may be unstable depending on the size of the plan-view shape and the etching conditions, due to process variation, and so on. Thus, the plan-view shape may be stable if it is a circular or elliptical shape with no corner portions. Also, the generation of the pressure P3 on the liquid surface of the adhesive 6 in each recess in the present disclosure occurs on condition that the adhesive forms a connected liquid surface inside the recess. Thus, if a connected liquid surface does not form due to the amount of the adhesive 6 or the dimensions of the recess, the effect of the present disclosure cannot be achieved. For reasons as described above, it is conceivable to employ a circular or elliptical plan-view shape.

Here, FIG. 21B illustrates a case where the plan-view shape is circular. As illustrated in FIG. 21B, there is no corner portion, and thus there is no adhesive 6 creeping along corner portions as in FIG. 21A. In this way, the adhesive 6 having flowed in from the joint surface of the recess can easily spread over the bottom surface on the second substrate 2. Thus, employing a circular or elliptical plan-view shape may make it easier for a connected liquid surface to form inside the recess and accordingly make it easier to achieve the effect of the present disclosure.

Specific examples of a case where the plan-view shape is circular or elliptical will be described below.

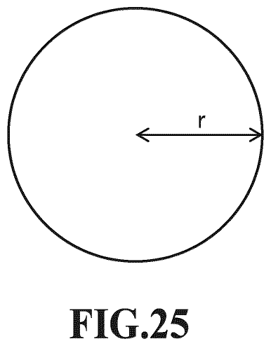

In a case where the plan-view shape is a circular shape with a radius r as illustrated in FIG. 25, D=2πr and S=πr², so that the pressure P3 is represented as P3=2γ cos θ/r. In view of the above-mentioned relation P1≥P3≥P2 and the wettability of the adhesive, it is preferable to set the plan-view shape such that 0≤35° and 1≥HD/2S≥0.15. Also, based on the above-mentioned equation, it is preferable to set the plan-view shape of each recess in relation to the substrate-to-substrate distance H at an opening end such that the range of 1≥H/r≥0.15 is satisfied. Further, it is more preferable to set the shape of each recess in relation to the substrate-to-substrate distance H at an opening end such that the range of θ≤30° and the range of 1≥H/r≥0.21 based likewise on the above-mentioned equation are satisfied. Furthermore, in this case, it is preferable that H be 1.5 μm or more and 4.0 μm or less.

For example, with a circular shape as illustrated in FIG. 25 with a radius r=10 μm taken as an example, H/r=0.3 if H=3.0 μm. Accordingly, the width of the recess and the substrate-to-substrate distance satisfy the above-mentioned relation. This makes it possible to control the protrusion of the adhesive.

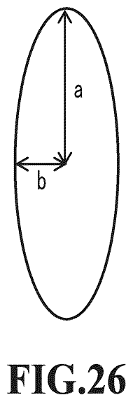

Also, in a case where the plan-view shape is an elliptical shape with a semi-major axis a and a semi-minor axis b as illustrated in FIGS. 26, D=2\sqrt{4(a−b)²+π²ab} and S=πab, so that the pressure P3 is represented as P3=2\sqrt{4(a−b)²+π²ab}γ cos θ/πab.

In view of the above-mentioned relation P1≥P3≥P2 and the wettability of the adhesive, it is preferable to set the plan-view shape such that θ≤35° and 1≥HD/2S≥0.15. Also, based on the above-mentioned equation, it is preferable to set the plan-view shape of each recess in relation to the substrate-to-substrate distance H at an opening end such that the range of 1≥H\sqrt{4(a−b)²+π²ab}/πab≥0.15 is satisfied. Further, it is more preferable to set the shape of each recess in relation to the substrate-to-substrate distance H at an opening end such that the range of 0≤30° and the range of 1≥H\sqrt{4(a−b)²+π²ab}/πab≥0.21 based likewise on the above-mentioned equation are satisfied. Furthermore, in this case, it is preferable that H be 1.5 μm or more and 4.0 μm or less.

For example, with an elliptical shape as illustrated in FIG. 26 with a semi-major axis a=30 μm and a semi-minor axis b=5 μm taken as an example, H\sqrt{4(a−b)²+π²ab}/πab=0.402 if H=3.0 μm. Accordingly, the widths of the recess and the substrate-to-substrate distance satisfy the above-mentioned relation. This makes it possible to control the protrusion of the adhesive.

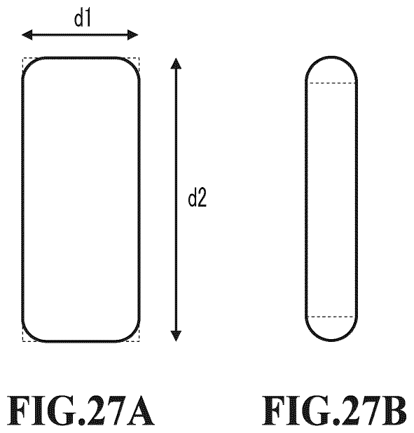

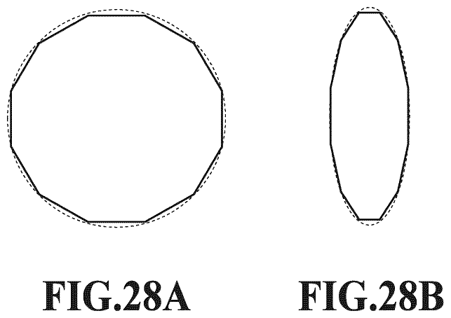

Incidentally, in a case where the plan-view shape of each recess is polygonal, the shapes of its corner portions may be deformed due to the etching or the like. As illustrated in FIG. 27A, for example, the corner portions may become rounded, in which case a fictious vertex may be created on an extension line from each side and used for the calculation. Also, as illustrated in FIG. 27B, in a case where the round shapes of the corner portions are larger than those in FIG. 27A, a circular shape and a rectangular shape may be combined and used for the calculation. Further, in a case where a polygonal shape with many corner portions as illustrated in FIG. 28A or 28B is employed but the etching affects the corner portions, resulting in a shape close to a circle or an ellipse, the plan-view shape may be approximated as the circular or elliptical shape and used for the calculation. In such a case, the calculation may result in some errors. For this reason, the recess is preferably such that the value of the pressure P3 can be set to be sufficiently different from the set values of the pressures P1 and P2. Specifically, the difference between the pressures P1 and P3 or between the pressures P2 and P3 is preferably 1000 Pa or more, for example.

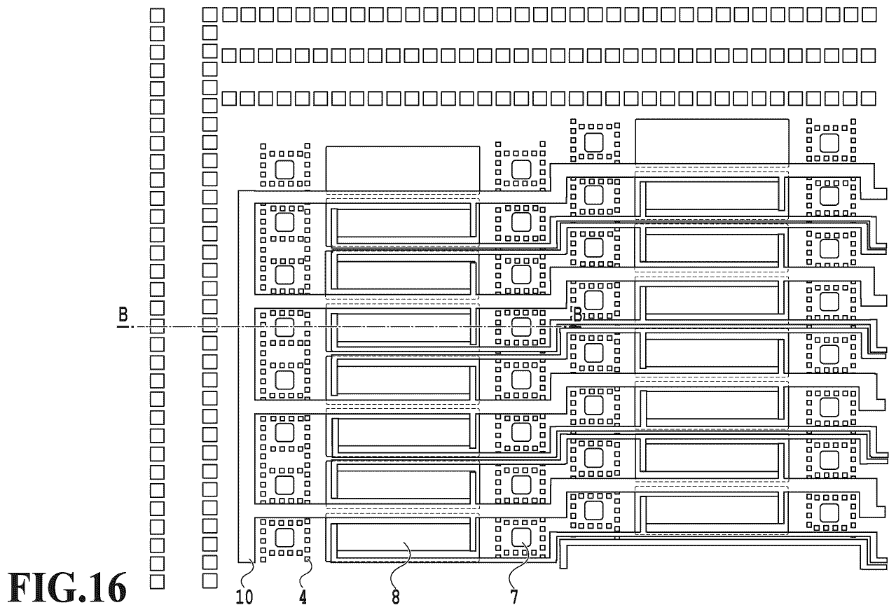

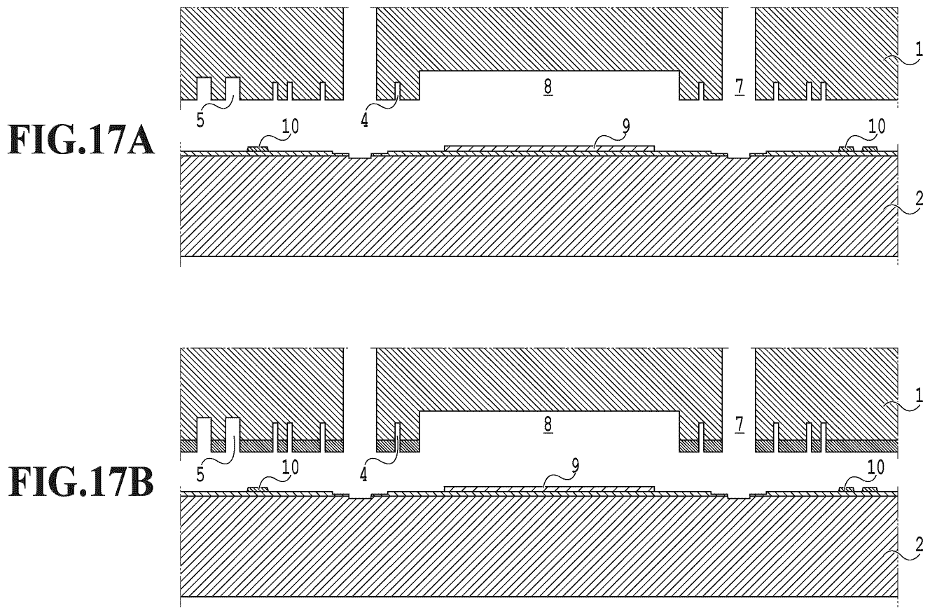

FIGS. 17A to 19B are cross-sections taken along the B-B′ line in FIG. 16 illustrating an example of a method of manufacturing a joined substrate in the present embodiment. Note that the substrate processing in the manufacturing of the joined substrate is not particularly limited, and common substrate processing is performed.

For example, in the case of a silicon substrate, a semiconductor manufacturing process can be used. The substrate can be processed by forming a desired etching mask on a surface of the substrate and then performing Si dry etching. The etching mask can be formed by patterning involving light exposure and development using a novolac photoresist, for example. For Si dry etching, an etching method using an SF₆ gas for an etching step and an C₄F₈ gas for a coating step, which is the so-called Botch process, can be used, for example. Also, a substrate thinning process and the like can be performed as necessary.

As illustrated in FIG. 17A, a first substrate 1 in which first and second openings 7 and 8 and first and second recesses 4 and 5 are formed and a second substrate 2 are prepared. These openings and recesses may be formed simultaneously or separately. Note that a case where only the first recesses 4 are formed between the first and second openings 7 and 8 is illustrated here, but only the second recesses 5 may be formed between them or both the first and second recesses 4 and 5 may be formed between them.

As illustrated in FIG. 17B, an adhesive 6 is formed onto the first substrate 1 by transfer. At this time, the adhesive 6 is not transferred into the first and second recesses 4 and 5 presented in the transfer surface.

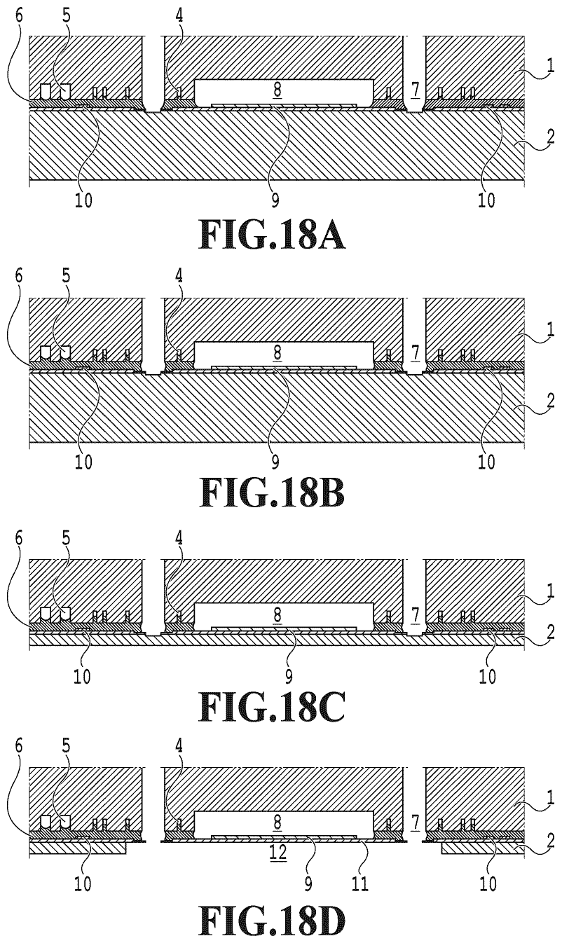

FIG. 18A is a schematic cross-sectional view of a state where the first substrate 1 and the second substrate 2, on which piezoelectric elements 9 and wirings 10 are formed, are attached to each other. At this time, the adhesive 6 moves into the first and second recesses 4 and 5 in the present embodiment. By subsequently curing the adhesive 6 while letting it sufficiently flow, the protrusion of the adhesive can be controlled (prevented), as illustrated in FIG. 18B.

As illustrated in FIG. 18C, the second substrate 2 is thinned down. Thereafter, as illustrated in FIG. 18D, the pressure chambers 12 are formed at positions corresponding to the piezoelectric elements 9. In the present embodiment, a process in which the pressure chambers 12 are formed after the second substrate 2 is joined and thinned down has been described by way of example. The manufacturing method is not limited to this, and the formation of the pressure chambers 12 may be preceded by joining the second substrate 2 that has been thinned down or the formation of the pressure chambers 12 may be followed by joining the second substrate 2.

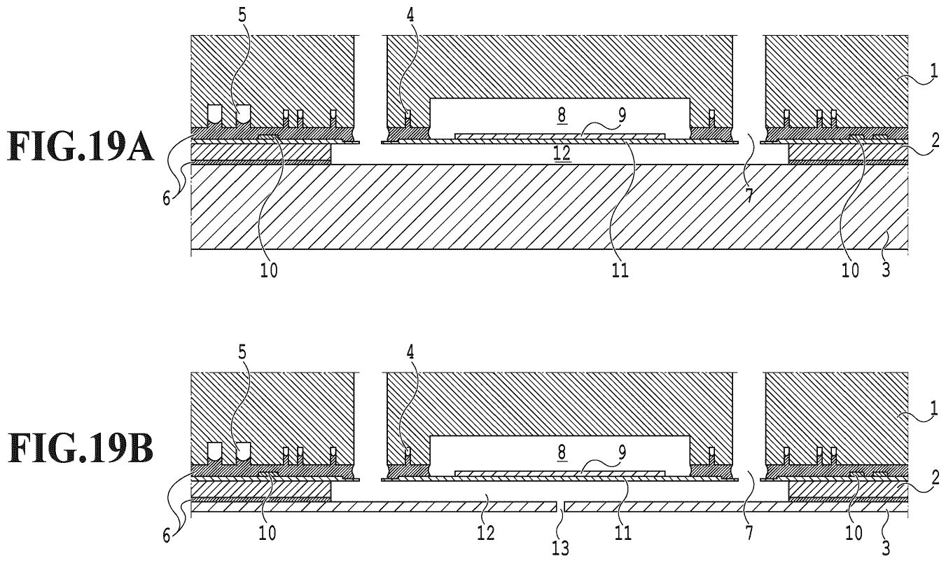

As illustrated in FIG. 19A, an adhesive 6 is transferred onto the second substrate 2, which is then joined to the third substrate 3. Incidentally, recesses for accommodating an excess adhesive are not illustrated in the second substrate 2 in FIG. 19A, but may be formed as necessary. The protrusion control with the recesses described in the present embodiment is also applicable to the joining of the second and third substrates 2 and 3.

As illustrated in FIG. 19B, the third substrate 3 is thinned down, and the ejection ports 13 are formed. Here, a process in which the ejection ports 13 are formed after the third substrate 3 is joined and thinned down has been described by way of example, but the manufacturing method is not limited to this process. For example, the formation of the ejection ports 13 may be preceded by joining the third substrate that has been thinned down or the formation of the ejection ports 13 may be followed by joining the third substrate. Also, a first channel (first opening 7) connecting to a first pressure chamber (pressure chamber 12) corresponding to a first actuator and a second channel (not illustrated) connecting to a second pressure chamber (not illustrated) corresponding to a second actuator may be formed in the first substrate 1 as ink channels. Recesses are disposed between these first and second channels at an appropriate distance or distances thereto.

As the adhesive 6, a material having good wettability on and high adhesion to the substrates is preferably used. Also, an adhesive made of a material that is resistant to inclusion of bubbles and the like is preferable, and an adhesive made of a material with low viscosity, which has high fluidity, is particularly preferable in the present embodiment. Moreover, it is preferable that such an adhesive contain any resin selected from the group consisting of an epoxy resin, an acrylic resin, a silicone resin, a benzocyclobutene resin, a polyamide resin, a polyimide resin, and a urethane resin.

Examples of the method of curing the adhesive 6 include a thermal curing method, an ultraviolet delayed curing method, and so on. Note that an ultraviolet curing method can be used in a case where any of the substrates has permeability to ultraviolet light. As for the method of applying the adhesive, the adhesive is applied to a dry film by spin coating and transferred onto one of the substrates on the joint surface. Note that the adhesive application method is not limited to this, and the adhesive may be applied by screen printing or by photolithographic patterning in the case of a photosensitive adhesive.

As for the curing of the adhesive 6, it is preferable to cure the adhesive after leaving it for a sufficient period of time in such a viscous state that it can flow. Alternatively, in a case where the adhesive 6 is a thermosetting resin, the heating device may be caused to slowly raise its temperature to set aside time for which the adhesive can flow.

In the present embodiment, benzocyclobutene, which is a thermosetting resin, can be preferably used. Benzocyclobutene is easily controllable because its viscosity varies with temperature, and since it exhibits a viscosity range of about 10 to 100 Poise during joining and curing, the capillary action in the first recesses 4 works effectively, and the adhesive easily flows into the second recesses 5.

In the curing, a common apparatus capable of baking under a vacuum of, for example, 10 Pa or less is used. The temperature is raised at a rate of 5° C./min up to 250° C., and then held at 250° C. for 1 hour to cure the adhesive. The adhesive can flow while the temperature is raised, in particular, while the temperature is raised through the range of 130 to 200° C., within which the viscosity is low. The adhesive curing conditions are not particularly limited, and can be changed as appropriate depending on the selected material. However, it is still preferable to set aside time for the adhesive to flow by, for example, lowering the rate of temperature rise and/or holding the temperature within a low-viscosity range.

As for the thickness of the adhesive, it is preferable to form it thickly in order to eliminate voids (bubbles) during the joining. An adhesive layer having a thickness that is at least 1.2 times the maximum distance between the first and second substrates 1 and 2 after the joining, more preferably at least 1.5 times the maximum distance, is preferably formed before the joining. It should be noted that increasing the thickness of the adhesive can avoid or reduce voids but increases the likelihood of protrusion of the adhesive into the openings in the joint surface.

### EXAMPLES

Examples of a joined substrate manufactured by the method in the above-described embodiment will be described below. Note that the substrate processing is not particularly limited, and common substrate processing was performed.

Also, calculations were performed using 0.02 N/m as the surface tension in the present disclosure. The same value as the angle formed between the adhesive in the solid state and each substrate that could be confirmed from the shape of a cross section after the curing was used as the contact angle of the adhesive in the pre-curing liquid state with the solid object while the adhesive flowed. Specifically, the calculations were performed using 15° as the contact angle.

Table 2 lists the values of parameters in examples. Specifically, Table 2 lists the substrate-to-substrate distance (the length of the joint surface in the Z direction) H between the first and second substrates, the X-direction width d1 and the Y-direction width d2 of a recess, the pressures P1 to P3 calculated from these values, and the relation of the protrusion length L in the cross-sectional shape after the curing. Note that the protrusion length is described as “Protrusion Amount” in Table 2.

TABLE 2

| | | | | | | | | | Confimed Resalt affo |
|---|---|---|---|---|---|---|---|---|---|
| | Setting Values | | | Calculation Xa | P2 | | | | Manufacturing |
| | H | d1 | d2 | P1 | (Pa) | P3 | P4 | H(1/d1 + | Protrusion Amount (μm): |
| | (μm) | (μm) | (μm) | (Pa) | *L = 1.0H | (Pa) | (Pa) | 1/d2) | Effect of Present Invention |
| Example 1 | 2.0 | 10 | 10 | 19319 | 7071 | 7727 | — | 0.40 | L < 2.0: Good |
| Example 2 | 4.0 | 10 | 50 | 9659 | 3536 | 4636 | — | 0.45 | L < 4.0: Good |
| Example 3 | 3.0 | 10 | 10 | 12879 | 4714 | 7727 | 7727 | 0.60 | L < 3.0: Good |
| | | 30 | 30 | | | 2576 | | | |
| Comparative | 2.0 | 30 | 50 | 39319 | 7071 | 2 [symbol] 61 | — | 0.13 | L > 2.0: Bad |
| Example 1 | | | | | | | | | |
| Comparative | 6.0 | 10 | 10 | 6440 | 2357 | 7727 | — | 1.20 | Drawn in: Bad |
| Example 2 | | | | | | | | | |

[symbol]

indicates data missing or illegible when filed

Table 3 lists the values of parameters of plan-view shapes in the examples. Specifically, Table 3 lists the substrate-to-substrate distance (the length of the joint surface in the Z direction) H between the first and second substrates, the entire circumference D and the area S calculated from the shape parameters of the plan-view shape, the pressures P1 to P3 calculated from these values, and the relation of the protrusion length L in the cross-sectional shape after the curing. Note that the protrusion length is described as “Protrusion Amount” in Table 3.

TABLE 3

| | | | | | | | | | | | Confirmed Result |
|---|---|---|---|---|---|---|---|---|---|---|---|
| | | | | | | Calculation Results | | | | | after Manufacturing |
| | Setting Values | | | | | | P2 | | | | Protrusion Amount |
| | | | Shape | | | | (Pa) | | | | (μm): |
| | H | Plan-view | Parameter | D | S | P1 | *L = | P3 | P4 | HD/ | Effect of Present |
| | (μ) | Shape | (μ) | (μ) | (μ²) | (Po) | 1.0H | (Pa) | (Pa) | 2S | Invention |
| Example 4 | 2.5 | Regular | a = 3 | 24 | 43.5 | 15455 | 5657 | 10669 | — | 0. [symbol] 90 | L < 2.5: Good |
| | | Octagon | | | | | | | | | |
| Example 5 | 1.5 | Hexagon | a1 = 3 | 24 | 25.79 | 25758 | 9428 | 17978 | — | 0.698 | L < 1.5: Good |
| | | | a2 = 6 | | | | | | | | |
| | | | a3 = 3 | | | | | | | | |
| | | | a4 = 3 | | | | | | | | |
| | | | a5 = 6 | | | | | | | | |
| | | | a6 = 3 | | | | | | | | |
| Example 6 | 2.5 | Hexagon | a1 = 3 | 24 | 34.46 | 15455 | 5657 | 13455 | — | 0.871 | L < 2.5: Good |
| | | | a2 = 6 | | | | | | | | |
| | | | a3 = 3 | | | | | | | | |
| | | | a4 = 3 | | | | | | | | |
| | | | a5 = 6 | | | | | | | | |
| | | | a6 = 3 | | | | | | | | |
| Example 7 | 3.0 | Regular | a = 3 | 3 [symbol] | 100.8 | 12879 | 4714 | 8902 | — | 0.536 | L < 3.0: Good |
| | | [symbol] | | | | | | | | | |
| | | (Circle) | ( [symbol] = 5.8) | (36.4) | (105.7) | | | (6662) | | (0.517) | |
| Example 8 | 2.5 | Circle | [symbol] = 4 | 25.1 | 50.3 | 15455 | 5657 | 9659 | — | 0.625 | L < 2.5: Good |
| Example 9 | 5.0 | Circle | [symbol] = 6 | 37.7 | 113.3 | 7327 | 2828 | 6440 | — | 0.833 | L < 5.0: Good |
| Example 10 | 2.0 | Ellipse | a = 10 | 43.4 | 78.5 | 19319 | 7071 | 10685 | — | 0.553 | L < 2.0: Good |
| | | | b = 2.5 | | | | | | | | |
| Example 11 | 4.0 | Ellipse | a = 1.5 | 67.5 | 233.6 | 9659 | 3536 | 5537 | — | 0.573 | L < 4.0: Good |
| | | | b = 5 | | | | | | | | |
| Example 12 | 3.0 | Circle | [symbol] = 4 | 25.1 | 50.3 | 12879 | 4714 | 9659 | 9659 | 0.750 | L < 3.0: Good |
| | | Ellipse | a = 1.5 | 79.5 | 471.2 | | | 3260 | | | |
| | | | b = 10 | | | | | | | | |
| Comparative | 2.5 | Hexagon | a1 = 3 | 24 | 25.79 | 15455 | 3657 | 17978 | — | 3.363 | Drawn in: Bad |
| Example 3 | | | a2 = 6 | | | | | | | | |
| | | | a3 = 3 | | | | | | | | |
| | | | a4 = 3 | | | | | | | | |
| | | | a5 = 6 | | | | | | | | |
| | | | a6 = 3 | | | | | | | | |
| Comparative | 1.5 | Circle | [symbol] = 13 | 94.2 | 706.9 | 25738 | 9428 | 2576 | — | 0. [symbol] | L > 1.3: Bad |
| Example 4 | | | | | | | | | | | |
| Comparative | 5.0 | Ellipse | a = 10 | 43.4 | 78.5 | 7727 | 2828 | 10685 | — | [symbol] .383 | Drawn in: Bad |
| Example 5 | | | b = 2.5 | | | | | | | | |

[symbol]

indicates data missing or illegible when filed

The first and second substrates were heated to 130° C. under a vacuum environment of 10 Pa to be attached using benzocyclobutene, which is a thermosetting resin, as the adhesive. Thereafter, under the vacuum environment of 10 Pa, the temperature was held at 150° C. for 30 minutes, followed by raising the temperature at a rate of 5° C./min to 250° C. and holding that temperature for 1 hour to thereby cure the adhesive. Lastly, after forming up to the ejection ports, the amount of protrusion of the adhesive and its shape in the cross section were confirmed to check whether the effect of the present disclosure was achieved.

### First Example

The first and second substrates were joined with a distance H=2.0 μm therebetween in a state where recesses having a width d1=10 μm and a width d2=10 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<2.0 μm and the effect of the present embodiment was achieved.

### Second Example

The first and second substrates were joined with a distance H=4.0 μm therebetween in a state where recesses having a width d1=10 μm and a width d2=50 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<4.0 μm and the effect of the present embodiment was achieved.

### Third Example

The first and second substrates were joined with a distance H=3.0 μm therebetween in a state where first recesses having a width d1=10 μm and a width d2=10 μm and second recesses having a width d1=30 μm and a width d2=30 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<3.0 μm and the effect of the present embodiment was achieved.

### First Comparative Example

The first and second substrates were joined with a distance H=2.0 μm therebetween in a state where recesses having a width d1=30 μm and a width d2=50 μm were disposed. A liquid ejection head equipped with this joined substrate was fixed and caused to perform single-color printing on a conveyed print medium. Streaks (unprinted regions) were observed. The liquid ejection head was actually disassembled and checked. It was confirmed that, in the present comparative example, the final protrusion length L was L>3.0 μm and the adhesive protruded into some of the channels in the joint surface. That is, the effect of the present embodiment was not achieved.

### Second Comparative Example

The first and second substrates were joined with a distance H=6.0 μm therebetween in a state where recesses having a width d1=10 μm and a width d2=10 μm were disposed. A liquid ejection head equipped with this joined substrate was fixed and caused to perform single-color printing on a conveyed print medium. Streaks (unprinted regions) were observed. The liquid ejection head was actually disassembled, and the final protrusion length was checked. It was confirmed to be likely that, in the present comparative example, the adhesive was drawn in from end portions of the substrate as illustrated in FIG. 10 and bubbles were trapped in voids in the joint surface. That is, the effect of the present embodiment was not achieved.

### Fourth Example

The first and second substrates were joined with a distance H=2.5 μm therebetween in a state where recesses whose plan-view shape was a regular octagonal shape with a side length a=3 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<2.5 μm and the effect of the present embodiment was achieved.

### Fifth Example

The first and second substrates were joined with a distance H=1.5 μm therebetween in a state where recesses whose plan-view shape was the hexagonal shape illustrated in FIG. 23 were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<1.5 μm and the effect of the present embodiment was achieved.

### Sixth Example

The first and second substrates were joined with a distance H=2.5 μm therebetween in a state where recesses whose plan-view shape was the hexagonal shape illustrated in FIG. 23 were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<2.5 μm and the effect of the present embodiment was achieved.

### Seventh Example

The first and second substrates were joined with a distance H=3.0 μm therebetween in a state where recesses whose plan-view shape was a regular dodecagonal shape with a side length a=3 μm were disposed. Also, taking the effect of the etching on the corner portions into consideration, calculations were performed for a circular shape with a radius r=5.8 μm. The calculated values were confirmed to be not greatly different. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<3.0 μm and the effect of the present embodiment was achieved.

### Eighth Example

The first and second substrates were joined with a distance H=2.5 μm therebetween in a state where recesses whose plan-view shape was a circular shape with a radius r=4 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<2.5 μm and the effect of the present embodiment was achieved.

### Ninth Example

The first and second substrates were joined with a distance H=5.0 μm therebetween in a state where recesses whose plan-view shape was a circular shape with a radius r=6 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<5.0 μm and the effect of the present embodiment was achieved.

### Tenth Example

The first and second substrates were joined with a distance H=2.0 μm therebetween in a state where recesses whose plan-view shape was an elliptical shape with a semi-major axis a=10 μm and a semi-minor axis b=2.5 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<2.0 μm and the effect of the present embodiment was achieved.

### 11th Example

The first and second substrates were joined with a distance H=4.0 μm therebetween in a state where recesses whose plan-view shape was an elliptical shape with a semi-major axis a=15 μm and a semi-minor axis b=5 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<4.0 μm and the effect of the present embodiment was achieved. [12th Example]

The first and second substrates were joined with a distance H=3.0 μm therebetween in a state where first recesses whose plan-view shape was a circular shape with a radius r=4 μm and second recesses whose plan-view shape was an elliptical shape with a semi-major axis a=15 μm and a semi-minor axis b=10 μm were disposed. A liquid ejection head equipped with this joined substrate was fixed and caused to perform single-color printing on a conveyed print medium. It was confirmed that the printing was performed with no problem. The liquid ejection head was actually disassembled and checked. It was confirmed that, in the present example, the final protrusion length L was L<3.0 μm and the effect of the present embodiment was achieved.

### Third Comparative Example

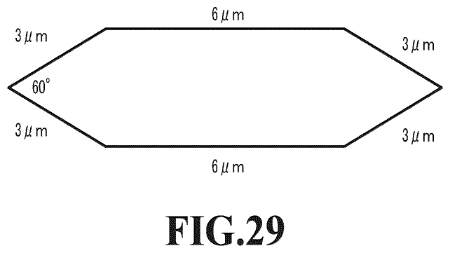

The first and second substrates were joined with a distance H=2.5 μm therebetween in a state where recesses whose plan-view shape was the hexagonal shape illustrated in FIG. 29 were disposed. A liquid ejection head equipped with this joined substrate was fixed and caused to perform single-color printing on a conveyed print medium. Streaks (unprinted regions) were observed. The liquid ejection head was actually disassembled, and the final protrusion length was checked. It was confirmed to be likely that, in the present comparative example, the adhesive was drawn in from end portions of the substrate as illustrated in FIG. 10 and bubbles were trapped in voids in the joint surface. That is, the effect of the present embodiment was not achieved.

### Fourth Comparative Example

The first and second substrates were joined with a distance H=1.5 μm therebetween in a state where recesses whose plan-view shape was a circular shape with a radius r=15 μm were disposed. A liquid ejection head equipped with this joined substrate was fixed and caused to perform single-color printing on a conveyed print medium. Streaks (unprinted regions) were observed. The liquid ejection head was actually disassembled and checked. It was confirmed that, in the present comparative example, the final protrusion length L was L>1.5 μm and the adhesive protruded into some of the channels in the joint surface. That is, the effect of the present embodiment was not achieved.

### Fifth Comparative Example

The first and second substrates were joined with a distance H=5.0 μm therebetween in a state where recesses whose plan-view shape was an elliptical shape with a semi-major axis a=10 μm and a semi-minor axis b=2.5 μm were disposed. A liquid ejection head equipped with this joined substrate was fixed and caused to perform single-color printing on a conveyed print medium. Streaks (unprinted regions) were observed. The liquid ejection head was actually disassembled, and the final protrusion length was checked. It was confirmed to be likely that, in the present comparative example, bubbles were trapped in voids in the joint surface. Specifically, the adhesive was drawn in from end portions of the substrate as illustrated in FIG. 10, and the effect of the present embodiment was not achieved.

### Application Example of Above-Described Example

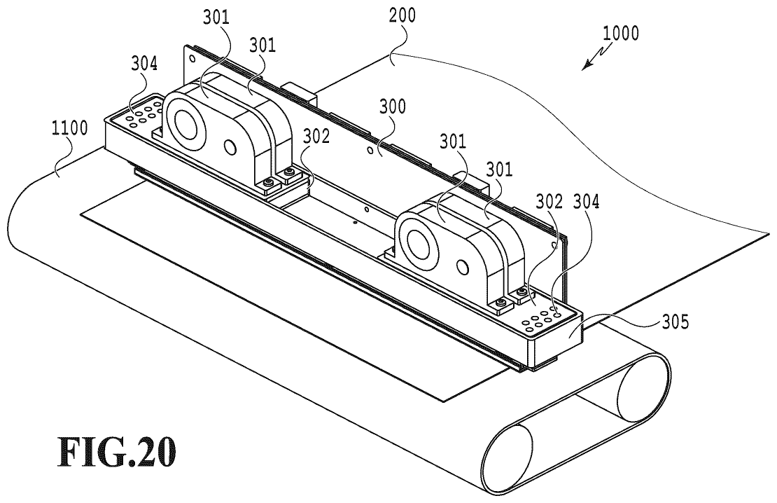

An application example of the joined substrate in one of the above-described examples will be described below using FIG. 20. FIG. 20 illustrates an example of a liquid ejection apparatus having a liquid ejection head manufactured using the joined substrate described in one of the above-described examples. In the following, an inkjet printing apparatus (hereinafter referred to as “printing apparatus”) 1000 that performs printing by ejecting inks will be described by way of example.

The printing apparatus 1000 is a line printing apparatus having a conveyance unit 1100 that conveys a print medium 200 and a line liquid ejection head 300 disposed substantially orthogonal to conveyance direction of the print medium 200. The printing apparatus 1000 performs printing while conveying the print medium 200.

The liquid ejection head 300 has: negative pressure control units 301 that control negative pressures in circulation paths; liquid supply units 302 fluidly communicating with the negative pressure control units 301; liquid connection portions 304 serving as supply ports and discharge ports through which to supply and discharge liquids to and from the liquid supply units 302; and a housing 305. The liquid ejection head 300 is capable of full-color printing with cyan (C), magenta (M), yellow (Y), and black (K) inks. Supply channels for supplying the inks to the liquid ejection head 300 and a main tank and buffer tank as a liquid supply unit are connected to the liquid ejection head 300 in such a manner as to allow the inks to flow. Also, an electric control unit that transfers electric power and ejection control signals to the liquid ejection head 300 is electrically connected to the liquid ejection head 300.

### Effect of Present Embodiment

Conventionally, in the manufacturing of a liquid ejection head, an adhesive may greatly protrude into regions accommodating energy generation elements, such as piezoelectric elements. This may affect the driving of these energy generation elements. In particular, in a case where opening that serve as ink channels are small, they can be easily closed by the adhesive, leading to a problem that troubles such as ink ejection failure occur.

These troubles will be severe if there is variation in the application and transfer of the adhesive in a case where the adhesive is required in a plentiful amount to fill steps formed by wirings present in the joint surface or in a case where the distance across the joint surface in the Z direction, i.e., the substrate-to-substrate distance, is long and requires the adhesive in a plentiful amount. To address this problem, a method has been conventionally employed in which large recesses capable of accommodating the adhesive are provided around the openings that serve as ink channels. However, only disposing these large recesses may not be sufficient to control the occurrence of the problem.

In view of this, in the present embodiment, the joined substrates 80 are manufactured by the above-described method, and a liquid ejection head is manufactured using the manufactured joined substrates 80. In the manufacturing method in the present embodiment, substrates having openings that serve as ink channels and openings that accommodate piezoelectric elements are attached with an adhesive therebetween such that recesses with which the pressures generated on the liquid surface of the adhesive satisfy the above-described predetermined condition are disposed.

The pressures mentioned above include three types of pressures. Specifically, one is the pressure P3 generated on the liquid surface of the adhesive at recesses that draw in the adhesive. Another one is the pressure P1 generated on a liquid surface being the end surface of the adhesive in the joint region between the first and second substrates. The last one is the pressure P2 generated on a liquid surface being the end surface of the adhesive in a case where the adhesive protrudes from the joint region. It is desirable to satisfy L=1.5H, where L is the protrusion length of the adhesive in the X direction in the case where the adhesive protrudes, and H is the substrate-to-substrate distance.

In the present embodiment, recesses having such widths that bring about such a drawing effect by a capillary action as to achieve P1≥P3≥P2 are appropriately disposed in a substrate. This makes it possible to control (prevent) protrusion of the adhesive into the openings accommodating energy generation elements and the openings serving as ink channels, and thus manufacture a stable joined substrate. Therefore, by using this joined substrate, a stable liquid ejection head can be manufactured.

According to the present disclosure, it is possible to accurately control the protrusion of an adhesive into openings provided in a substrate of a liquid ejection head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2024-187559 filed Oct. 24, 2024, and No. 2025-123336, filed Jul. 23, 2025, which are hereby incorporated by reference herein in their entirety.

What is claimed is:

1. A liquid ejection head comprising:
a first substrate; and
a second substrate joined to the first substrate with an adhesive therebetween, wherein
an opening portion that serves as a channel and a recess are formed in at least one of the first substrate or the second substrate, and
1≥H(1/d1+1/d2)≥0.15 is satisfied, where d1 is a width of the recess in a traverse direction of the first substrate, d2 is a width of the recess in a longitudinal direction of the first substrate, and His a substrate-to-substrate distance between the first substrate and the second substrate in a lamination direction of the first substrate and the second substrate.

2. The liquid ejection head according to claim 1, wherein 1≥H(1/d1+1/d2)≥0.21 is satisfied.

3. A liquid ejection apparatus comprising
a liquid ejection head including
a first substrate, and
a second substrate joined to the first substrate with an adhesive therebetween, wherein
an opening portion that serves as a channel and a recess are formed in at least one of the first substrate or the second substrate, and
1≥H(1/d1+1/d2)≥0.15 is satisfied, where d1 is a width of the recess in a traverse direction of the first substrate, d2 is a width of the recess in a longitudinal direction of the first substrate, and His a substrate-to-substrate distance between the first substrate and the second substrate in a lamination direction of the first substrate and the second substrate.

4. The liquid ejection apparatus according to claim 3, wherein 1≥H(1/d1+1/d2)≥0.21 is satisfied.

5. A liquid ejection head comprising:
a first substrate; and
a second substrate joined to the first substrate with an adhesive therebetween, wherein
an opening portion that serves as a channel and a recess are formed in at least one of the first substrate or the second substrate, and
1≥HD/2S≥0.15 is satisfied, where D is an entire circumference of a plan-view shape of the recess of the first substrate parallel to a joint surface, S is an area of the plan-view shape, and His a substrate-to-substrate distance between the first substrate and the second substrate in a lamination direction of the first substrate and the second substrate.

6. The liquid ejection head according to claim 5, wherein 1≥HD/2S≥0.21 is satisfied.

7. The liquid ejection head according to claim 5, wherein
the plan-view shape of the recess of the first substrate parallel to the joint surface is a circular shape with a radius r, and
1≥H/r≥0.15 is satisfied, where H is the substrate-to-substrate distance between the first substrate and the second substrate in the lamination direction of the first substrate and the second substrate.

8. The liquid ejection head according to claim 5, wherein
the plan-view shape of the recess of the first substrate parallel to the joint surface is a circular shape with a radius r, and
1≥H/r≥0.21 is satisfied, where H is the substrate-to-substrate distance between the first substrate and the second substrate in the lamination direction of the first substrate and the second substrate.

9. The liquid ejection head according to claim 5, wherein
the plan-view shape of the recess of the first substrate parallel to the joint surface is an elliptical shape with a semi-major axis a and a semi-minor axis b, and
1≥H\sqrt{4(a−b)²+π²ab}/πab≥0.15 is satisfied, where H is the substrate-to-substrate distance between the first substrate and the second substrate in the lamination direction of the first substrate and the second substrate.

10. The liquid ejection head according to claim 5, wherein
the plan-view shape of the recess of the first substrate parallel to the joint surface is an elliptical shape with a semi-major axis a and a semi-minor axis b, and
1≥H\sqrt{4(a−b)²+π²ab}/πab≥0.21 is satisfied, where H is the substrate-to-substrate distance between the first substrate and the second substrate in the lamination direction of the first substrate and the second substrate.

11. The liquid ejection head according to claim 5, wherein
the plan-view shape of the recess of the first substrate parallel to the joint surface is an n-gonal shape, and
$$1 \geq H {\sum }_{i = 1}^{n} a i / 2 {\sum }_{i = 1}^{n} Si \geq 0.15$$
is satisfied, where a1, a2, . . . , and an are each a length of one side of the n-gonal shape, S1, S2, . . . , Sn are each an area of a region formed by lines connecting a center and adjacent vertices of the plan-view shape, and H is the substrate-to-substrate distance between the first substrate and the second substrate in the lamination direction of the first substrate and the second substrate.

12. The liquid ejection head according to claim 5, wherein
the plan-view shape of the recess of the first substrate parallel to the joint surface is an n-gonal shape, and
$$1 \geq H {\sum }_{i = 1}^{n} a i / 2 {\sum }_{i = 1}^{n} \geq 0.21$$
is satisfied, where a1, a2, . . . , and an are each a length of one side of the n-gonal shape, S1, S2, . . . , Sn are each an area of a region formed by lines connecting a center and adjacent vertices of the plan-view shape, and H is the substrate-to-substrate distance between the first substrate and the second substrate in the lamination direction of the first substrate and the second substrate.

13. The liquid ejection head according to claim 5, wherein
the plan-view shape of the recess of the first substrate parallel to the joint surface is a regular n-gonal shape (n=4), and
1≥2H tan(180/n)/a≥0.15 is satisfied, where a is a length of one side of the regular n-gonal shape, an angle formed by straight lines connecting a center and adjacent vertices of the plan-view shape is) 360/n(°), and H is the substrate-to-substrate distance between the first substrate and the second substrate in the lamination direction of the first substrate and the second substrate.

14. The liquid ejection head according to claim 5, wherein
the plan-view shape of the recess of the first substrate parallel to the joint surface is a regular n-gonal shape (n=4), and
1≥2H tan(180/n)/a≥0.21 is satisfied, where a is a length of one side of the regular n-gonal shape, an angle formed by straight lines connecting a center and adjacent vertices of the plan-view shape is) 360/n(°), and H is the substrate-to-substrate distance between the first substrate and the second substrate in the lamination direction of the first substrate and the second substrate.
